(19) United States
(12) Patent Application Publication
(10) Pub. No.: US 2004/0051849 A1
(43) Pub. Date: Mar. 18, 2004

(54) Projection device with wireless devices

(76) Inventor: Huang Shin-Pin, Taipei (TW)

Correspondence Address: HARNESS, DICKEY & PIERCE, P.L.C., P.O. BOX 828, BLOOMFIELD HILLS, MI, 48303, US

(21) Appl. No.: 10/661,022

(22) Filed: Sep. 12, 2003

(30) Foreign Application Priority Data
Sep. 13, 2002 (TW) 91214526

(51) Int. Cl. G03B 21/26

(52) U.S. Cl. 353/30

(57) ABSTRACT

A projection device with wireless devices is provided. The projection device with wireless devices includes a video camera for providing a camera signal a wireless transmitter electrically connected to the video camera for receiving the camera signal and transmitting the camera signal by means of a wireless transmission technology; a wireless receiver for receiving the camera signal and transforming the camera signal into a projection signal; and a projector electrically connected to the receiver for receiving the projection signal and projecting an image in response to the projection signal.

### CROSS-REFERENCE TO RELATED APPLICATIONS

This application claims benefit of Taiwan Patent Application, Serial Number 91214526 filed on Sep. 13, 2002. The disclosure of the above application is incorporated herein by reference.

### FIELD OF THE INVENTION

The present invention relates to a projection device, and more particularly, to a projection device with wireless devices.

### BACKGROUND OF THE INVENTION

As the computer is available to all, the peripheral devices are more and more popular. One of them is the projector. The common basic requests for a projector are portability, light-weight, and usage convenience. Nowadays, the projector is developed in the direction with compact size, lightweight and high quality.

The direct projector can project objects directly. Since there is no need to make transparencies, it largely reduces time to prepare a presentation All you can see can be projected through the direct projector clearly and without losing the fidelity of the objects.

When the direct projector projects the image of the object it needs not convert the image first and is able to project the image onto a wall directly. The steps of direct projecting are: catching the image of objects via a particular CCD (charged-coupled device) camera; converting analog signals into digital signals via LSI (Large-Scale Integration); and providing digital signals to the projector, so as to finish the projecting process.

Presently, there are two kinds of direct projection devices which are classified by size: the fixed projector and the portable projector. The advantage of the fixed projector is the highly powerful function, which can project the real images of the objects, films, and transparencies onto a wall. It has the function of electrical focusing and can enlarge image with steplessly adjustable value. It also has multi-signal input/output, so that it can be used as a central controller however, the disadvantages of the fixed projector are bulky size and heavy weight. Besides, it also needs additional data input devices to be the data sources when using. And a fixed projector with high quality usually has a higher price. On the other hand, the advantages of the portable projector are the light-weight feature, and the data input device is built in with. With the exception that the portable projector can't project films and transparencies, the other functions of that can entirely compare with the functions of a professional projector.

Unfortunately, in the foregoing direct projectors, the CCD camera has to be held on an arm member with a predetermined distance apart from the material on the table to ensure a required shooting distance. The CCD camera is electrically connected to the projector by a wire or is built in the projector directly. Because the position and the angle of the CCD camera are restricted which will limit the application of the projector.

From the above description, it is known that the conventional direct projector is not very practical when the user needs to adjust the position and the angle of CCD camera. What is needed is an apparatus that is designed for projecting documents or images, which allows the documents or images to be easily transmitted by radio signals, and which can project objects without the limitation for the position and location of the CCD camera.

### SUMMARY OF THE INVENTION

It is the main object of the present invention to provide a projection device with wireless devices.

It is another object of the present invention to provide a projection device which is able to receive a radio signal and transmit a radio signal so as to project the images onto a wall.

It is another object of the present invention to provide a projection device which allows the CCD camera to be located at a remote location apart from the projector.

It is another object of the present invention to provide a projection device without any external wires which connects the CCD camera with the projector so as to avoid the troublesome wire arrangement.

According to one aspect of the present invention, the projection device includes a video camera for providing a camera signal; a wireless transmitter electrically connected to the video camera for receiving said camera signal and transmitting the camera signal by means of a wireless transmission technology; a wireless receiver for receiving the camera signal and transforming the camera signal into a projection signal; and a projector electrically connected to the receiver for receiving the projection signal and projecting an image in response to the projection signal.

Preferably, the camera signal includes an audio signal and a video signal.

Certainly, the wireless transmission technology can be a radio frequency technology

Certainly, the wireless transmission technology can be a wireless local area network technology.

Certainly, the wireless transmission technology can be a Bluetooth technology.

Certainly, the wireless transmission technology can be an infrared technology.

According to another aspect of the present invention, the projection device includes a wireless receiver for receiving a radio signal and transforming the radio signal into a projection signal; and a projector electrically connected to the wireless receiver for projecting an image according to the projection signal.

Preferably, the camera signal includes an audio signal and a video signal.

Preferably, the radio signal is provided by a video camera.

Preferably, the video camera further comprises a wireless transmitter.

Preferably, the video camera electrically connects thereto a wireless transmitter for transmitting said radio signal through a wireless transmission technology.

Certainly, the wireless transmission technology can be a radio frequency technology.

Certainly, the wireless transmission technology can be a wireless local area network technology.

Certainly, the wireless transmission technology can be a Bluetooth technology.

Certainly, the wireless transmission technology can be an infrared technology.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a projection device with wireless devices according to a preferred embodiment of the present invention;

FIG. 2 illustrates a projection device with wireless devices according to another preferred embodiment of the present invention;

FIG. 3 illustrates a projection device with wireless devices connected with a computer according to another preferred embodiment of the present invention;

FIG. 4 illustrates a projection device with wireless devices according to another preferred embodiment of the present invention; and

FIG. 5 illustrates a projection device with wireless devices connected with a computer according to another preferred embodiment of the present invention.

### DETAILED DESCRIPTION OF THE PREFERRED EMBODIMENTS

The following description of the preferred embodiment is merely exemplary in nature and is in no way intended to limit the invention, its application, or uses.

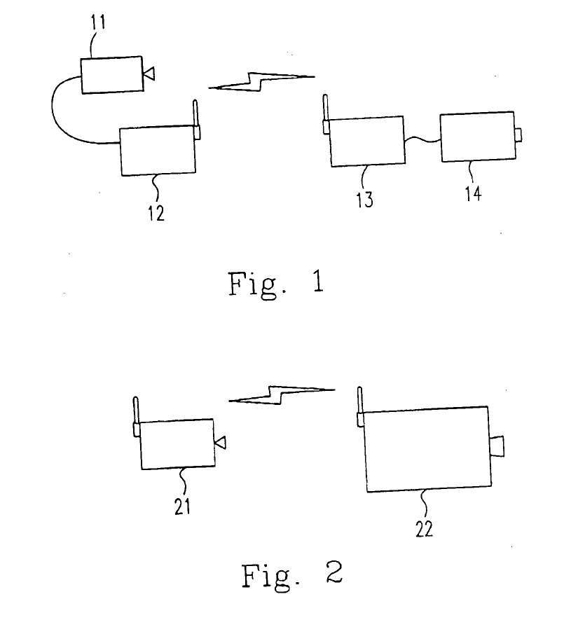

The present invention will now be described more specifically with reference to the following embodiment. Please refer to FIG. 1. Fig. I illustrates a projection device with wireless devices according to a first preferred embodiment of the present invention. The projection device includes a video camera 11, a wireless transmitter 12, a wireless receiver 13 and a projector 14. The wireless transmitter 12 is electrically connected to the video camera 11. The projector 14 is electrically connected to the receiver 13. The wireless transmission technology used in the wireless transmitter/receiver of the present invention is primarily based on the wireless local area network (WLAN), Bluetooth, and infrared (IrDA).

Accordingly, the video camera 11 shoots the projected object first and provides a camera signal to the wireless transmitter 12. The wireless transmitter 12 receives the camera signal and transmits the camera signal by means of a wireless transmission technology. Then, the wireless receiver 13 receives the camera signal and transforms the camera signal into a projection signal which is then transmitted to the projector 14. Finally, the projector 14 receives the projection signal and projects the image in response to the projection signal. Thus, a projecting process is completed.

Please refer to FIG. 2. FIG. 2 illustrates a projection device with wireless devices according to a second preferred embodiment of the present invention. The projection device includes a video camera 21 and a projector 22. Meanwhile, the video camera 21 has a built-in wireless transmitter for providing a camera signal by means of a wireless transmission technology The wireless receiver is built in the projector 22 for receiving the camera signal and transforming the camera signal into a projection signal. Therefore, the projector 22 receives the projection signal and projects the image in response to the projection signal. In such a way, the projection device is simplified.

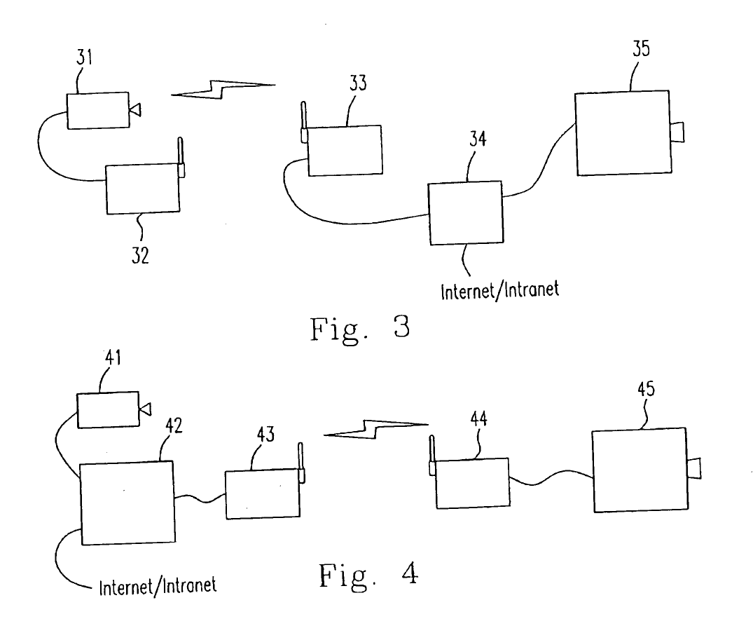

Please refer to FIG. 3. FIG. 3 illustrates a projection device with wireless devices according to a third preferred embodiment of the present invention. As shown in FIG. 3, the projection device of the present invention can be applied to a video conference. The projection device includes a video camera 31, a wireless transmitter 32, a wireless receiver 33, a computer 34 and a projector 3$. The wireless transmitter 32 is electrically connected to the video camera 31. The computer 34 is electrically connected to the wireless receiver 33 and the internet/intranet.

Similarly, the video camera 31 shoots the projected object first and provides a camera signal to the wireless transmitter 32. The wireless transmitter 32 receives the camera signal and transmits the camera signal to the wireless receiver 33. When the wireless receiver 33 receives the camera signal, it will transform the camera signal into a computer signal and then transmit the computer signal to the computer 34. After the computer signal is processed by a video conference software, the computer 34 will output a projection signal to the projector 3$. The projector 35 then projects the image onto a wall in response to the projection signal. In such a way, the images can be transmitted through the internet/intranet by the software before projected.

Please refer to FIG. 4. FIG. 4 illustrates a projection device with wireless devices according to a forth preferred embodiment of the present invention. The projection device includes a video camera 41, a computer 42, a wireless transmitter 43, a wireless receiver 44 and a projector 45. The computer 42 is electrically connected to the video camera 41 and the internet/intranet. The wireless transmitter 43 is electrically connected to the computer 42. The projector 45 is electrically connected to the receiver 44.

Similarly, the video camera 41 shoots the projected object first and provides a camera signal to the computer 42. After the camera signal is processed by a video conference software, the computer outputs a computer signal to the wireless transmitter 43. The wireless transmitter 43 receives the computer signal and transmits the computer signal by means of a wireless transmission technology to the projector 45 via the wireless receiver 44. The projector 45 receives the projection signal and projects an image onto a wall in response to the projection signal.

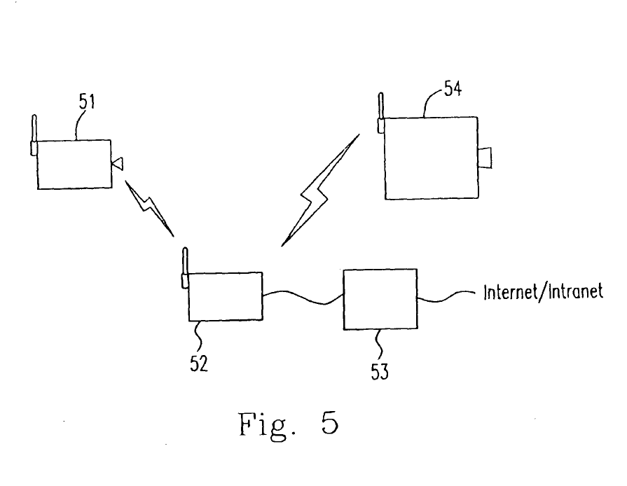

Please refer to FIG. 5. FIG. 5 illustrates a projection device with wireless devices according to a fifth preferred embodiment of the present invention. The projection device includes a video camera 51, a wireless transmitter/receiver 52, a computer 53, and a projector 54. The video camera 51 has a built-in wireless transmitter for providing a camera signal by means of a wireless transmission technology. The wireless transmitter/receiver 52 is electrically connected to the computer 53. And the computer 53 is connected to the internet/intranet.

Accordingly, after the projected object is shot, the video camera 51 provides a camera signal to the wireless transmitter/receiver 52 by means of a wireless transmission technology. The wireless transmitter/receiver 52 receives the camera signal and transforms the camera signal into a computer signal. Then, the computer 53 receives the computer signal which is then processed by a video conference software, so that the computer 53 outputs a projection signal to the wireless transmitter/receiver 52 again. Then, the wireless transmitter/receiver 52 transmits the projection signal to the projector 54 by means of a wireless transmission technology. Finally, the projector 54 receives the projection signal and projects an image on to a wall in response to the projection signal. Therefore, since the transmitter/receiver 52 is connected to the computer 53 that is connected to the internet/intranet, the projection device can certainly be used for video conference when a meeting needs to be held between two business locations.

According to the above, the projection device with wireless devices provided in the present invention includes wireless receiver and transmitter which can receive and transmit radio signals. Therefore, the positions and angles of both video camera and projector won't be limited anymore. Besides, it doesn't need a signal line to connect the projection device with a signal source. The projection device provided in this invention is very attractive and practical for a lecturer. In addition, there is no need to nut wires under carpets or through walls. The lecturer needs not worry about arranging the signal wire on the table or floor every time they come into the conference room. Wireless networking provides connectivity without the hassle and cost of wiring. Even if the business location moves, the network is ready for use as soon as the projector is moved.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation, so as to encompass all such modifications and similar structures. According, the invention is not limited by the disclosure. but instead its scope is to be determined entirely by reference to the following claims.

What is claimed is:

1. A projection device, comprising:
a video camera for providing a camera signal;
a wireless transmitter electrically connected to said video camera for receiving said camera signal and transmitting said camera signal by means of a wireless transmission technology;
a wireless receiver for receiving said camera signal and transforming said camera signal into a projection signal; and
a projector electrically connected to said receiver for receiving said projection signal and projecting an image in response to said projection signal.

2. The device according to claim 1, wherein said camera signal includes an audio signal and a video signal.

3. The device according to claim 1, wherein said wireless transmission technology is a wireless local area network technology.

4. The device according to claim 1, wherein said wireless transmission technology is a Bluetooth technology.

5. The device according to claim 1, wherein said wireless transmission technology is an infrared technology.

6. The device according to claim 1, wherein said wireless transmission technology is a radio frequency technology.

7. A projection device comprising:
a wireless receiver for receiving a radio signal and transforming said radio signal into a projection signal; and
a projector electrically connected to said wireless receiver for projecting an image according to said projection signal.

8. The device according to claim 6, wherein said radio signal includes an audio signal and a video signal.

9. The device according to claim 6, wherein said radio signal is provided by a video camera.

10. The device according to claim 8, wherein said video camera further comprises a wireless transmitter.

11. The device according to claim 8, wherein said video camera electrically connects thereto a wireless transmitter for transmitting said radio signal through a wireless transmission technology.

12. The device according to claim 10, wherein said wireless transmission technology is a wireless local area network technology.

13. The device according to claim 10, wherein said wireless transmission technology is a Bluetooth technology.

14. The device according to claim 10, wherein said wireless transmission technology is an infrared technology.

15. The device according to claim 10, wherein said wireless transmission technology is a radio frequency technology.
